(19) United States
(12) Patent Application Publication
(10) Pub. No.: US 2011/0314963 A1
(43) Pub. Date: Dec. 29, 2011

(54) CONTROLLABLE CONSTANT SPEED GEARBOX

(75) Inventor: Richard A. Poisson, Avon, CT (US)

(73) Assignee: HAMILTON SUNDSTRAND CORPORATION, Windsor Locks, CT (US)

(21) Appl. No.: 12/824,732

(22) Filed: Jun. 28, 2010

(51) Int. Cl. F16H 37/06

(52) U.S. Cl. 74/665 F

(57) ABSTRACT

An engine mountable gearbox is provided and includes a body formed to define a plurality of connection points at which a main engine generator and one or more accessories are mounted, a first transmission disposed within the body at the connection point of the main engine generator to run the main engine generator at a controlled constant speed at varying speeds of the engine rotation and a second transmission disposed within the body at least at one of the connection points of the one or more accessories to run the one of the one or more of the accessories at a controlled constant speed at varying speeds of the engine rotation.

### BACKGROUND OF THE INVENTION

The subject matter disclosed herein relates to a constant speed transmission embedded in a transmission.

In a gas turbine engine, the auxiliary gearbox transfers power from a main shaft of the engine to an oil-cooled generator for generating electrical power and to engine accessories such as the fuel control unit, the lube module and cooling fan. In addition, there is also a starter motor connected through the gear train to perform a starting function.

Currently, the auxiliary gearbox of a gas turbine engine rotates at the speed of the gas turbine engine. However, because the accessories attached to the gearbox must operate over a large range of speeds, the speed of the gas turbine engine is often different from the operating speeds of the accessories. This speed differential between the auxiliary gearbox and the accessories leads to operational inefficiency and a requirement that over capacity be designed into the components.

### BRIEF DESCRIPTION OF THE INVENTION

According to one aspect of the invention, an engine mountable gearbox is provided and includes a body formed to define a plurality of connection points at which a main engine generator and one or more accessories are mounted, a first transmission disposed within the body at the connection point of the main engine generator to run the main engine generator at a controlled constant speed at varying speeds of the engine rotation and a second transmission disposed within the body at least at one of the connection points of the one or more accessories to run the one of the one or more of the accessories at a controlled constant speed at varying speeds of the engine rotation.

According to another aspect of the invention, an engine mountable gearbox is provided and includes a body formed to define a plurality of connection points at which a main engine generator and one or more accessories are mounted, a gear train rotatable with engine rotation and disposed within the body to transmit the engine rotation to the main engine generator and the one or more accessories, a first transmission coupled to the gear train at the connection point of the main engine generator to run the main engine generator at a controlled constant speed at varying speeds of the engine rotation and a second transmission coupled to the gear train at least at one of the connection points of the one or more accessories to run the one of the one or more of the accessories at a controlled constant speed at varying speeds of the engine rotation.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a gearbox;

FIG. 2 is a schematic view of a differential, variable displacement hydraulic units and fixed displacement hydraulic units of the gearbox of FIG. 1;

FIG. 3 is another schematic view of a differential, variable displacement hydraulic units and fixed displacement hydraulic units of the gearbox of FIG. 1; and

FIG. 4 is yet another schematic view of a differential, variable displacement hydraulic units and fixed displacement hydraulic units of the gearbox of FIG. 1.

The detailed description explains embodiments of the invention, together with advantages and features, by way of example with reference to the drawings.

### DETAILED DESCRIPTION OF THE INVENTION

In accordance with aspects of the invention, an auxiliary gearbox, a gearbox or a section of a gearbox having a controlled frequency may eliminate inefficiency and a requirement for over capacity. Such a gearbox utilizes a constant speed transmission that allows for a constant frequency electrical output from a generator. By using this type of transmission embedded in a gearbox, at least a section of the gearbox can be made so that all components attached to this section would run at a controllable constant speed. For example, the current horsepower (HP) capacity of an integrated drive generator (IDG) is about 120 HP and, as such, a fuel pump, an engine pump and motor assembly (PMA), and any other equipment that runs up to 120 HP can be run at a controlled constant speed. This speed could be further controlled for each stage of flight.

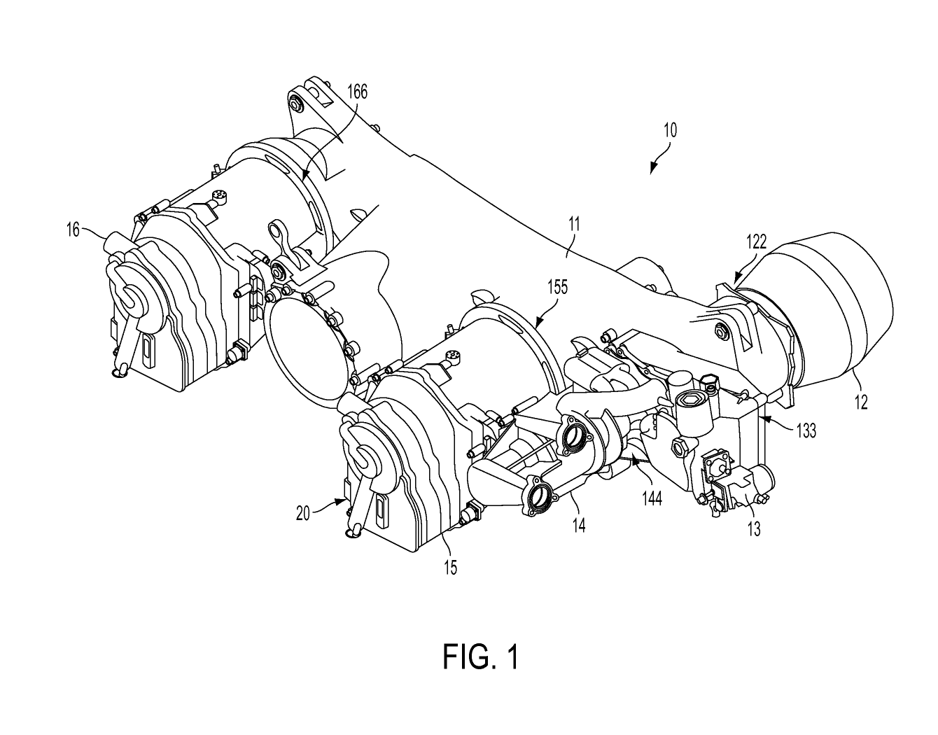

With reference to FIG. 1, operation of the IDG is initiated with startup of an aircraft engine. When the aircraft engine starts to rotate, a gear train 11 of the accessory gearbox body 10 is rotated. This leads to rotation of a hydraulic pump 12, a fuel mixing unit 13, a main fuel pump 14, an output gear 15, a starter/generator 16 and a generator 20, such as a main engine generator. As shown, the hydraulic pump 12 is coupled to the gearbox body 10 at a first connection point 122, the fuel mixing unit 13 is coupled to the gearbox body 10 at a second connection point 133, the main fuel pump 14 is coupled to the gearbox body 10 at a third connection point 144, the starter/generator 16 is coupled to the gearbox body 10 at a fourth connection point 166 and the output gear 15 and the generator 20 are coupled to the gearbox body 10 at a fifth connection point 155. The hydraulic pump 12, the fuel mixing unit 13, the main fuel pump 14, the starter/generator 16 and the generator 20 are each representative of equipment that could be run at the controlled constant speed.

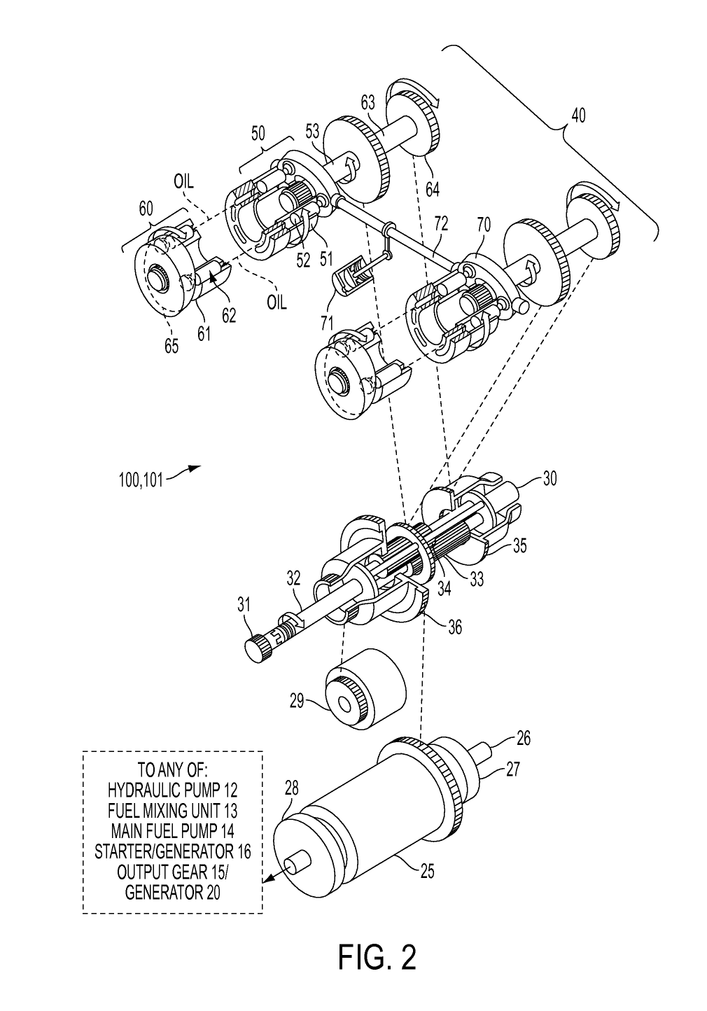

For example, with reference to FIGS. 2, 3 and 4, the output gear 15, which normally drives the generator 20, and the main fuel pump 14 of FIG. 1 are each configured to be power controlled through first and second transmissions 100, 101 that are similar in arrangement and each include a differential, variable displacement hydraulic units and fixed displacement hydraulic units, as described below. Here, while the first and second transmissions 100, 101 are being described as relating to the driving of the output gear 15 and the main fuel pump 14, it is understood that the first and second transmission 100, 101 could be adapted to control any or all of the above-mentioned components.

As shown in FIGS. 2, 3 and 4, an input shaft 30 is coupled to a main rotor 25 and secondary rotors 26 and 27 of, for example, the output gear 15, the generator 20 and/or the main fuel pump 14. The input shaft 30 is further coupled to an accessory gear 29, which transfers rotation to a governor, a scavenge/inversion pump and a charge pump. Here again, although the main rotor 25 is described as being coupled to the output gear 15, the generator 20 and/or the main fuel pump 14, it is understood that the main rotor 25 could be coupled to any of the hydraulic pump 12, the fuel mixing unit 13, the starter/generator 16 of FIG. 1 or any other accessory.

The input shaft 30 includes an input spline 31 that couples a carrier shaft 32 directly to the gearbox 10 via the main rotor 25. The carrier shaft 32 always turns in one direction with a speed proportional to engine speed. First and second planet gears 33 and 34 on the carrier shaft 32 engage with each other and rotate independently of the carrier shaft 32 as they orbit around a centerline thereof. A fixed unit ring gear 35 and an output ring gear 36 are added to the carrier shaft 32 with the fixed unit ring gear 35 engaged with the first planet gear 33 and the output ring gear 36 engaged with the second planet gear 34. With this construction, when the fixed unit ring gear 35 is stationary, rotation of the carrier shaft 32 causes the first planet gear 33 to rotate while orbiting around an inside of the fixed unit ring gear 35 with the second planet gear 34, which is engaged with the first planet gear 33, transferring rotation to the output ring gear 36 and causing the output ring gear 36 to rotate at twice the speed of the carrier shaft 32.

Because of this 2 to 1 ratio between the output ring gear 36 and the carrier shaft 32, when the fixed unit ring gear 35 is held stationary and the carrier shaft 32 is turned at a given revolutions per minute (rpm), the output speed will be twice that given rpm. If input speed is less than the given rpm, speed must be added to maintain a constant output speed and, to do this, the fixed unit ring gear 35 is rotated in the opposite direction of the carrier shaft 32 rotation, thereby applying increased rotational speed to the first planet gear 33 engaged with the fixed unit ring gear 35. Here, as the first planet gear 33 turns faster, the second planet gear 34 also turns faster thereby causing output speed to increase. This is an overdrive condition. When the input speed is above the given rpm, speed must be subtracted and, to do this, the fixed unit ring gear 35 is rotated in the same direction as the carrier shaft 32, reducing the rotational speed on the first planet gear 33 engaging with the fixed unit ring gear 35. Because the second planet gear 34 engages with the first planet gear 33, its speed is also reduced, thereby reducing the speed of the output ring gear 36. This is an underdrive condition. Therefore, the output speed can be controlled by the rotational direction and speed of the fixed unit ring gear 35.

Directional control and speed control of the fixed unit ring gear 35 rotation is accomplished by units 40. Each of the units 40 includes variable units 50 and fixed units 60. The fixed units 60 include a cylinder block 61 having pistons 62. The cylinder block 61 connects to a shaft 63 with a gear 64, which is engaged with the fixed unit ring gear 35. The pistons 62 in the cylinder block 61 reciprocate by moving on a fixed wobbler plate 65 which forms an inclined plane. The direction of rotation that the fixed units 60 assume is controlled by the variable units 50. This is accomplished by positioning a variable wobbler plate 70 on one side or another of a zero angle position. The angle of the variable wobbler plate 70 determines the displacement of the variable units 50, which controls the rotational speed of the fixed units 60.

Each variable unit 50 includes a cylinder block 51 with pistons 52. The cylinder block 51 is splined to a shaft 53, which is driven by the carrier shaft 32. Because the carrier shaft 32 is coupled to the input shaft 30, the variable units 50 will always rotate in one direction and at a speed proportional to the speed of the engine. The pistons 52 work against the face of the variable wobbler plate 70. As the position of the variable wobbler plate 70 is moved from its zero angle position, oil is ported from the fixed units 60 to the variable units 50 or vice versa depending on the angle of the variable wobbler plate 70.

In the overdrive phase, as shown in FIG. 2, when the input speed is below straight-through speed, the variable wobbler plate 70 is moved into an angular position opposite the fixed wobbler plate 65 position which pumps high volume oil from the variable units 50 to the fixed units 60. The variable wobbler plate 70 position is achieved by the exertion of pressure on the control piston 71, which moves axially in response, to thereby rotate plate shaft 72, which is coupled to variable wobbler plate 70. The fixed units 60 are rotated in a direction opposite that of the variable units 50 and the fixed unit ring gear 35, being engaged with the fixed units 60, will rotate in a direction opposite that of the carrier shaft 32, thereby adding to the output speed.

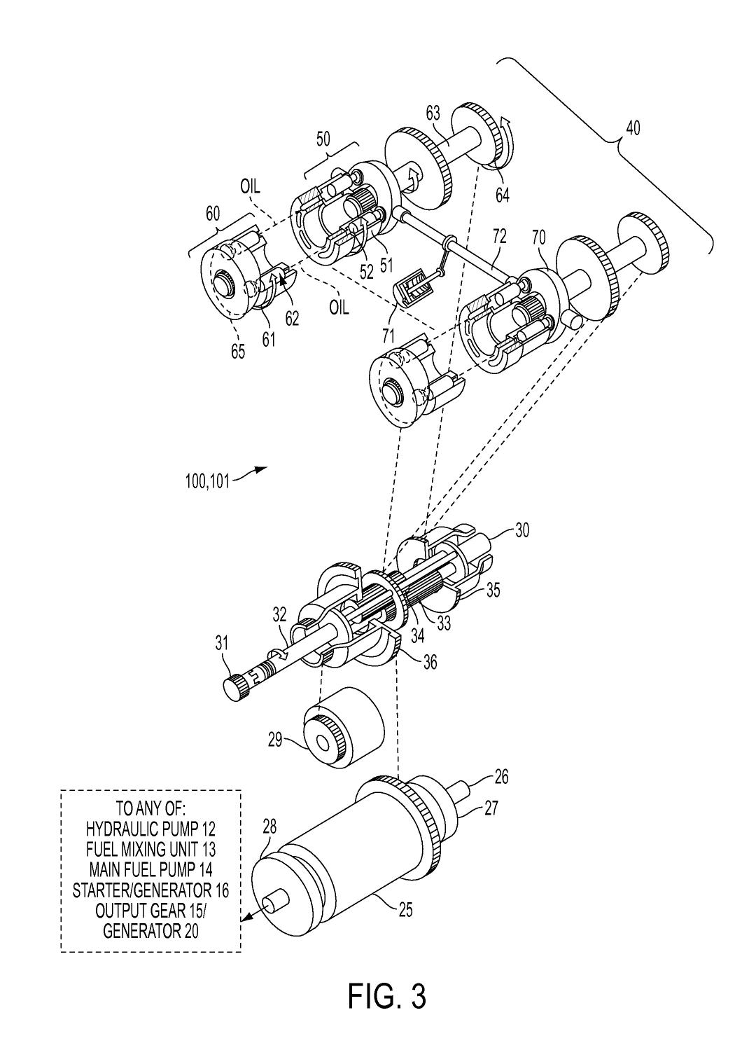

In the underdrive phase, as shown in FIG. 3, when the input speed is above straight-through speed, the variable wobbler plate 70 is moved into an angular position paralleling the fixed wobbler plate 65 position, which allows high pressure oil to be pumped from the fixed units 60 to the variable units 50. Here, the fixed unit ring gear 35 is engaged with the fixed units 60 to rotate in the same direction as the carrier 32 shaft and subtract from the output speed.

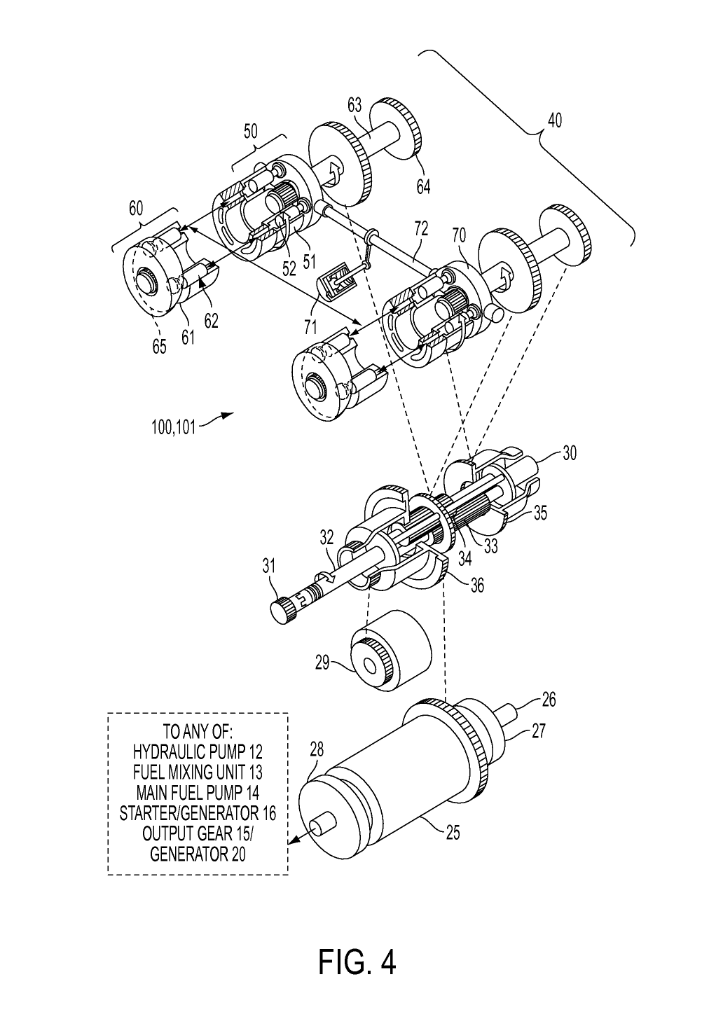

In the straight-through drive phase, as shown in FIG. 4, when the input speed is sufficient to maintain a desired output speed, the variable wobbler plate 70 is at a zero angle position or is at a slight angle in the amount necessary to compensate for internal leakage. With the variable wobbler plate 70 in this position, the variable unit 50 pistons 52 do not reciprocate. Therefore, the fixed units 60, which no longer receive or send pressurized oil, stop rotating. Here, the fixed unit ring gear 35, which is engaged with the fixed units 60, also stops turning. With the fixed unit ring gear 35 stopped, input rotation is transferred directly through the differential.

In accordance with aspects of the invention, the differential, the variable displacement hydraulic units and the fixed displacement hydraulic units can be employed with the main rotor 25 of the generator 20. The same type of differential, variable displacement hydraulic units and fixed displacement hydraulic units can be used with main rotors of one or more of the hydraulic pump 12, the fuel mixing unit 13, the main fuel pump 14 and the starter/generator 16. Thus, any one or more of each of these components may be run at the controlled constant speed at varying speeds of the engine rotation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An engine mountable gearbox, comprising:
a body formed to define a plurality of connection points at which a main engine generator and one or more accessories are mounted;
a first transmission disposed within the body at the connection point of the main engine generator to run the main engine generator at a controlled constant speed at varying speeds of engine rotation; and
a second transmission disposed within the body at least at one of the connection points of the one or more accessories to run the one of the one or more of the accessories at the controlled constant speed at varying speeds of the engine rotation.

2. The engine mountable gearbox according to claim 1, wherein the one or more accessories comprises a hydraulic pump.

3. The engine mountable gearbox according to claim 1, wherein the one or more accessories comprises a fuel mixing unit.

4. The engine mountable gearbox according to claim 1, wherein the one or more accessories comprises a transfer gearbox.

5. The engine mountable gearbox according to claim 1, wherein the one or more accessories comprises a starter/generator.

6. The engine mountable gearbox according to claim 1, wherein the first transmission is disposed at an output gear coupled to the main engine generator.

7. The engine mountable gearbox according to claim 1, wherein the first and second transmissions are each operable in an underdrive phase, an overdrive phase and a straight-through phase.

8. The engine mountable gearbox according to claim 7, wherein the first and second transmissions each comprise first and second planet gears coupled to an input shaft that are rotatable at various relative speeds in the underdrive phase, the overdrive phase and the straight-through phase.

9. The engine mountable gearbox according to claim 8, wherein the first and second transmissions each comprise fixed and variable displacement hydraulic units to drive the first and second planet gears.

10. The engine mountable gearbox according to claim 9, wherein the first and second transmissions further comprise fixed and variable wobbler plates to govern operation of the fixed and variable displacement hydraulic units.

11. The engine mountable gearbox according to claim 10, wherein an angular position of the variable wobbler plate relative to the fixed wobbler plate of each of the first and second transmission determines whether the first and the second transmission operates in the underdrive phase, the overdrive phase and the straight-through phase.

12. An engine mountable gearbox, comprising:
a body formed to define a plurality of connection points at which a main engine generator and one or more accessories are mounted;
a gear train rotatable with engine rotation and disposed within the body to transmit the engine rotation to the main engine generator and the one or more accessories;
a first transmission coupled to the gear train at the connection point of the main engine generator to run the main engine generator at a controlled constant speed at varying speeds of the engine rotation; and
a second transmission coupled to the gear train at least at one of the connection points of the one or more accessories to run the one of the one or more of the accessories at the controlled constant speed at varying speeds of the engine rotation.

13. The engine mountable gearbox according to claim 12, wherein the one or more accessories comprises a hydraulic pump.

14. The engine mountable gearbox according to claim 12, wherein the one or more accessories comprises a fuel mixing unit.

15. The engine mountable gearbox according to claim 12, wherein the one or more accessories comprises a transfer gearbox.

16. The engine mountable gearbox according to claim 12, wherein the one or more accessories comprises a starter/generator.

17. The engine mountable gearbox according to claim 12, wherein the first transmission is disposed at an output gear disposed between the gear train and the main engine generator.

18. The engine mountable gearbox according to claim 12, wherein the first and second transmissions are each operable in an underdrive phase, an overdrive phase and a straight-through phase.

19. The engine mountable gearbox according to claim 18, wherein the first and second transmissions each comprise:
first and second planet gears coupled to an input shaft that are rotatable at various relative speeds in the underdrive phase, the overdrive phase and the straight-through phase; and
fixed and variable displacement hydraulic units to drive the first and second planet gears.

20. The engine mountable gearbox according to claim 19, wherein the first and second transmissions further comprise fixed and variable wobbler plates to govern operation of the fixed and variable displacement hydraulic units, an angular position of the variable wobbler plate relative to the fixed wobbler plate of each of the first and second transmission determining whether the first and the second transmission operates in the underdrive phase, the overdrive phase and the straight-through phase.
